(19) United States
(12) Patent Application Publication
(10) Pub. No.: US 2021/0086577 A1
(43) Pub. Date: Mar. 25, 2021

(54) VEHICLE

(71) Applicant: INNOVATIVE DRAGON LTD., London (GB)

(72) Inventor: Herwig FISCHER, Willich (DE)

(21) Appl. No.: 16/630,773

(22) PCT Filed: Jun. 19, 2018
(86) PCT No.: PCT/EP2018/066173

§ 371 Date: Jan. 13, 2020

(30) Foreign Application Priority Data
Jul. 14, 2017 (DE) 10 2017 115 838.3
Sep. 13, 2017 (DE) 10 2017 008 583.8
Mar. 17, 2018 (DE) 10 2018 002 181.6

(51) Int. Cl. B60G 17/016; B60K 7/00; B60K 31/00; G05D 1/02; B60N 2/01; B60N 2/14

(52) U.S. Cl. CPC B60G 17/0162; B60K 7/0007; B60K 31/0066; G05D 1/0287; B60N 2/01; B60N 2/14; G05D 2201/0213; B60G 2202/412; B60G 2202/413; B60G 2202/42; B60G 2800/012; B60K 2031/0091; B60G 2200/10; B60G 2204/62

(57) ABSTRACT

A vehicle, in particular a single-track vehicle, has a small track width in relation to the vehicle height, and three or four wheels. In order to provide a vehicle which allows for a high traffic flow speed at a high traffic density, the vehicle has automatically controlled tilt kinematics, in which the vehicle body and the wheels tilt about a longitudinal axis of the vehicle.

### CROSS REFERENCE TO RELATED APPLICATIONS

This application is a United States National Phase Application of International Application PCT/EP2018/066173, filed Jun. 19, 2018, and claims the benefit of priority under 35 U.S.C. § 119 of German Applications 10 2017 115 838.3, filed Jul. 14, 2017, 10 2017 008 583.8, filed Sep. 13, 2017, and 10 2018 002 181.6, filed Mar. 17, 2018, the entire contents of which are incorporated herein by reference.

### TECHNICAL FIELD

The present invention relates to a vehicle, in particular a single-track vehicle, having a small track width in relation to the vehicle height, and three or four wheels.

### TECHNICAL BACKGROUND

In particular in urban areas having a high population density, it is increasingly noticeable that the constantly increasing need for mobility is leading to roads becoming jammed and quick travel progress being impossible, in particular at rush hour, which affects commuters in particular. Since there is still a significant need for individual mobility, there have been many attempts to increase the vehicle density on the roads in congested urban areas, without negatively affecting the flow speed of the traffic in the process. For example, comparatively short passenger cars have been developed, which, at a length of approximately 2.5 m, require little space compared with larger limousines. It is disadvantageous that generous safety distances between the vehicles of up to 25 m have to be maintained, in urban traffic, during travel, with the result that the effect of the small and short passenger car on the traffic flow is almost entirely lost.

A promising concept for increasing the traffic density while keeping the same flow speed is that of introducing comparatively narrow vehicles, such that a plurality of vehicles can travel in parallel on a conventional traffic lane having a width of generally between 2.75 m and 3.75 m. Since vehicles of this kind that have a small track width in comparison with the vehicle height are susceptible to tipping, in particular in the case of cornering, the maximum speed is to be limited accordingly, which in turn has a negative effect on the traffic flow. It has not been possible for concepts to date, at least, to catch on in practice, according to which concepts vehicles having a narrow track width, as tilting three- or four-wheel vehicles, are known. A tilting vehicle of this kind is for example known as the Toyota i-Road. In this case, complicated kinematics from a combination of steering and tilting on two parallel wheels have been avoided, in that the drive and tilt control means have been attached to the front axle, and the steering means to the rear axle which, however, in the case of the mentioned Toyota i-Road comprises just one wheel. In addition to the disadvantages of worse tipping resistance of a three-wheel design of this kind, in this case very uneven and unstable steering behavior is accepted. In addition, the rear axle of the vehicle swivels towards the outside of the curved track, resulting in the risk of the vehicle becoming stuck on a curbside. For these reasons, said vehicles are limited to a very low speed level. Furthermore, every driver has to undertake training.

### SUMMARY

An object of the present invention is therefore that of providing a vehicle that allows for a high traffic flow speed at a high traffic density.

This object is achieved by the vehicle comprising automatically controlled tilt kinematics, in which the vehicle body and the wheels tilt about a longitudinal axis of the vehicle. As a result, the vehicles having a narrow track width in relation to the vehicle height can travel around a bend in a steady manner and at a comparatively high speed, and are furthermore also protected against tipping due to cross-winds, lateral gradients or the like. In known concepts of narrow-track vehicles comprising tilt kinematics, the tilt and balance is applied by the driver of the vehicle and, in contrast to the present invention, not controlled automatically.

Preferred embodiments of the present invention will be explained in the following.

According to a first preferred embodiment of the invention, the vehicle has a track width of less than 1.2 m, preferably less than 1.0 m, and/or a height of at least 1.30 m, so as to allow for people to comfortably get into the vehicle and/or to allow for a comfortable sitting position for people inside the vehicle. Preferably, at the same track width of less than 1.2 m, a vehicle height of from approximately 1.80 m to 1.90 m is provided, such that tall people can also easily get into the vehicle and stand up inside the vehicle, for example in order to get out of said vehicle. Irrespective of the overall height of a vehicle according to the invention, the narrow track width of less than 1.2 m in particular ensures that a plurality of vehicles can travel on one conventional lane, which in itself significantly relieves the traffic flow.

The automatically controlled tilt kinematics is preferably configured as vehicle stabilization, which automatically prevents tipping of the vehicle in the case of bends, in cross-wind, when people get in, and/or in the case of inclinations of the carriageway. In particular in the event of the vehicle tilting at bends, the present automatic tilt kinematics can be distinguished from conventional tilt mechanics, which only allow for tilting that is intentionally initiated by the driver, in that it leans into the bend, for example, in the case of cornering. However, the present automatically controlled tilt kinematics allows for the required tilt angle to be predetermined, which angle is subsequently set by correspondingly designed actuators.

According to a further preferred embodiment of the invention, the wheels and the vehicle body tilt by the same angle, upon tilting, such that the wheel planes and the vehicle body are oriented so as to be mutually parallel, irrespective of the tilt angle, which significantly increases the driving stability, in cornering, compared with those vehicles in which the vehicle body is tilted independently of the wheels.

It has already been noted that the present vehicle differs from known vehicle comprising tilting technology, in that an automatic controller determines the angle about which the vehicle must, if necessary, be tilted. In this respect, according to a preferred embodiment the vehicle according to the invention comprises target value regulation which determines the magnitude and the direction of the tilting from input parameters, in particular from the upcoming bend radius, the upcoming gradient and the upcoming carriageway inclination, the vehicle speed and the vehicle mass distribution, the transverse acceleration, a possible asymmetric entry load, and a decentral load distribution inside the vehicle, the cross-wind, and/or lateral impacts. These input parameters (the list of which is not exclusive) are continuously checked during travel, and the tilt angle is adjusted accordingly. In this case, the tilt of the vehicle is automatically controlled, in each position, such that the resultant of all the acting forces, in particular the gravitational force and the centrifugal force, is oriented so as to be substantially in parallel with the direction of the vertical axis of the vehicle body and of the passenger compartment. Said equilibrium of forces means that passengers do not experience any transverse accelerations, and therefore are substantially unaffected by the cornering itself.

According to a particularly preferred embodiment, the present vehicle is designed as an electric vehicle, with the result that the electrical energy available is limited. Since tilting of the vehicle by means of corresponding actuators is associated with significant electrical energy consumption, according to an advantageous embodiment of the present invention a breakdown torque is generated by means of steering in the opposite direction from the upcoming trajectory, in particular in the case of cornering, such that bends to the left are introduced by means of counter steering to the right, and vice versa. The counter steering means that some amount of basic tilting in the correct direction is already set when at the start of the bend, without actuators having to actively intervene for the purpose of tilting. The tilt of the vehicle is therefore set, because the upper part of the vehicle remains in the current position, owing to the inertia, whereas the lower part of the vehicle is already pivoted in a direction, by means of the counter steering. As a result, a tilt of the vehicle is already set, without a significant electrical energy requirement, which tilt is subsequently optimized, depending on the input parameters described above.

In order to further increase the comfort for passengers, according to a particularly preferred embodiment of the invention, steering angle actuators and tilt actuators are provided, which are designed such that the virtual tilting axis of the vehicle is at a height of from 1.5 m to 1.8 m above the contact planes. In the vehicles according to the invention, this is the height at which the passenger's heads are generally located, and therefore the heads coincide with the virtual tilting axis. As a result, the occurrence of motion sickness in passengers is effectively prevented, and, furthermore, a corresponding sense of comfort results during travel, owing to the lack of transverse accelerations in the region of the head.

According to a particular embodiment of the vehicles according to the invention, and a particularly communication-friendly embodiment, the seats are arranged in an opposing orientation inside the vehicle, such that passengers assume a face-to-face position during travel. This orientation of the seats presupposes that the vehicle is an autonomous self-driving vehicle, which is the preferred embodiment of the vehicles comprising tilt kinematics.

According to a preferred embodiment of the invention, the vehicles comprise a variable interior, such that it is optionally possible to transport a further passenger, luggage, or other loads.

In order to further increase the driving stability, according to a further preferred embodiment of the invention, the tires of the wheels have a round cross section, such that, at bends, the contact plane is formed by the tire walls.

Furthermore, in order to allow for the tipping movement, various wheel suspensions or actuators are provided, specifically wheel suspensions and/or actuators
on double crossmembers,
comprising linear guides having ball bearing circulation, a spindle drive, or electromagnetic coils,
comprising torsion bars, or
comprising trailing arms having a rotary bearing.
In order to set the tilt, in particular an actuator system is provided that contains a spindle drive, hydraulics, pneumatics, and/or electromagnetic coils. The last-mentioned electromagnetic coils form an electromagnetic linear actuator, i.e. comprise a magnetic metal cylinder in a coil. If the coil is energized, the cylinder moves axially out of the coil and tips the vehicle.

According to a particularly preferred embodiment of the present invention, the vehicle has 4-wheel steering and/or a 4-wheel hub drive, such that the vehicle can travel in both directions, without any restriction. The vehicle thus defined provides the possibility of merging into traffic quickly, in all directions, which significantly increases the flow speed of the traffic, and, in particular in autonomous operation, multiplies said flow speed.

Furthermore, a vehicle of this kind is preferably designed as a fully self-driving vehicle. Alternatively, an embodiment of the vehicle as a driven vehicle is also provided, for which purpose the driver merely requires a normal driving license, because, apart from the tilt kinematics, the vehicle can be controlled in a conventional manner. The steering movement is applied directly by the driver, as a path transmission, by means of a control element, such as a steering wheel, or a yoke, or a steering rod. The appropriate side tilting of the vehicle is adjusted according to the velocity at the bend radius, the carriageway gradient, and/or the force of the cross-wind. For this purpose, automatic closed-loop control is provided, preferably consisting of a sensor system, controller, regulation means, and actuator system, such that the driver does not have to ensure the lateral balance when stationary or during travel, as is the case in a two-wheeled vehicle. Instead, the vehicle can be controlled, on the roadway, in the manner of a conventional passenger car.

The present vehicle is based substantially on a four-wheel concept, comprising a geometrically clean steering trapeze and slip-free rolling conditions in all driving states with front-wheel steering, such that it can be driven in the manner of a conventional passenger car. The steering comprises a direct force transmission between the steering knuckles and the steering wheel. The transmission is achieved by means of mechanical decoupling kinematics or hydraulic force transmission, which in both cases is designed as directional control, i.e. not drive-by-wire. As a result, the required properties such as steering force profile, differentiation, restoring force, damping, steering feel, and shimmy tendency, can be adjusted freely, as in the case of a conventional passenger car.

Owing to the small width, the vehicles can, depending on the country either freely or with special authorization, continue to travel, in the event of a traffic jam, on the free side in the center between the queuing passenger cars. In the long term, the creation of special lane is also possible. For travel of this kind, and also for operation in pedestrian zones or otherwise traffic-restricted regions, GPS-monitored speed limits are provided in the vehicles, i.e. in a pedestrian zone or in traffic jam situations the vehicles cannot exceed specified speed limits. For the purpose of traffic jam identification, software is installed that identifies the stationary or extremely slowly travelling traffic as a traffic jam, by means of sensors, in particular ultrasound, radar, camera and/or LIDAR systems having corresponding software. In a particular embodiment, the positive identification of a traffic jam is displayed visually and acoustically on the vehicle so as to be identifiable from outside, e.g. by means of light signals, such that the remaining traffic can react accordingly, in particular by freeing the central region, not zigzagging, and/or keeping doors closed. Furthermore, this display can also be used for monitoring of improper use, by the police.

The vehicle is designed as a one-seater or two-seater vehicle, wherein in the latter case a tandem arrangement is preferred. In an advantageous embodiment, the vehicle comprises a completely closed cabin and can be used in the manner of a passenger car. All the occupants are secured by seatbelts and do not need to wear helmets.

In order to ensure the smooth running of the complex kinematics of steering and tilting, as well as suspension and damping, a software prevents kinematic combinations that are not expedient and are seldom required. Thus, in a particular variant, the tilt angle is restricted in the case of extreme steering angles, in order that the pivot areas in the wheel region do not become too large. As soon as the region of this restriction is approached, the driver is provided with a visual or acoustic warning.

In order to also render the vehicle usable for customers who have only a limited driving license, e.g. 16-year-olds, the vehicle is cleared for different speeds by means of coded software.

In order to increase the driving safety, the vehicle according to the invention has a speed limit that is controlled by GPS and cartography, by means of which e.g. accident blackspots, zebra crossings, tight bends, etc. are identified and the available maximum speed is set and/or displayed to the driver.

In a further embodiment, not only is the width of the vehicle reduced to approximately half that of a conventional passenger car, but the length is also limited to 2.8 m, preferably 2.6 m or less, such that 4 vehicles can park on a standard parking space for a passenger car. Furthermore, having these dimensions, the vehicle can thus also be carried transversely on an external bracket on the rear of a passenger car or motorhome. In order to minimize the weight in this type of operation, the battery can preferably be removed for this purpose. This system allows for the vehicle to be passively carried over long distances, in order to then be used on the edge of the city, at a Park and Ride.

The vehicle is preferably electrically driven. In order for it to be possible to charge the battery everywhere, the battery is accommodated in a housing that is designed in a manner similar to a trolley case, and in addition to travel casters comprises a preferably telescopic handle and can easily be removed from the outside and carried along for charging, e.g. in a home or at work, in an office. For this purpose, the battery merely has to be pulled by the handle, and otherwise rolls on the ground, so that the driver does not have to bear the generally high weight of a suitable battery.

In a particular embodiment, the vehicle according to the invention comprises a teach function and a steering actuator, as a result of which repeated driving routes can be driven autonomously. In order to allow for this function in a cost-effective manner, the journeys are controlled by open-loop, not closed-loop, control. In order to minimize the risk of collision in this case, the speed in this mode is reduced to e.g. 5 km/h, such that collision identification is possible using simple ultrasound sensors or the like. Owing to the small width, in this mode the vehicle does not constitute an obstacle, despite the low speed, since, on all roads of a normal width, sufficient space remains for all passenger cars to overtake.

Furthermore, in a future, more established state of market penetration, visual or other markings are provided in carparks, on parking decks, or on private land, by which the vehicle can be autonomously guided for driverless journeys of this kind,

In a particular embodiment, instead of a second seat, the vehicle comprises stowage spaces that are accessible from the inside and/or outside, such that use as a delivery vehicle for last mile/post/parcel delivery or pizza delivery is possible, wherein it is again found to be advantageous that the vehicle does not block an entire lane when parking at the edge of the road.

In a particular embodiment, the kinematics of the automatic rolling is selected such that the virtual axis of rotation is located in the center of the carriageway. In particular variants, the tilt control is introduced by means of pilot control, such that the rotational acceleration directly, and does not have to first counteract the already established lateral forces. In a special variant, said pilot control is triggered by the steering movement. In this case, said pilot control is parameterized such that the driver can intuitively learn the steering movement that is optimum for travel comfort.

In addition to the design of the kinematics, in a further variant each suspension arm and/or chassis support, in particular the right-hand and the left-hand tilt regulation, is actuated by means of separate actuators. In this embodiment, tilt regulation about the transverse axis (i.e. the longitudinal tilt) is also possible, and provided depending on the model.

In a variant having a particularly sporty design, the chassis kinematics is designed such that the track width increases as the tilt angle increases.

In order to be able to reach the maximum tilt angle without contact with the ground, the suspension is locked when a threshold angle is reached.

In order to maximize the driving safety, a visual or acoustic signal is output when particular threshold values of the chassis kinematics are reached, in particular the maximum control speed of the tilt actuators or the maximum tilt angle.

In a particularly convenient embodiment, the kinematics of the rolling is designed such that the virtual axis is positioned above the carriageway, such that the acceleration forces acting on the occupants, in particular at head height, are reduced.

The supporting structure of the vehicle is preferably tapered at the ends, such that the likelihood of a head-on or offset collision with total absorption of the kinetic energy is significantly reduced.

In a particularly cost-saving version, the vehicle is designed as a cage structure comprising hollow profiles.

The known mobility concepts comprising self-driving vehicles are subject to utilization limits, since transport at the edges of the territories cleared for said vehicles, e.g. on the edges of towns, cannot be continued in the same vehicle. The passenger has to change to a different mode of transport that must also be available on the arterial roads, in order to prevent waiting times. In particular, however, daily commuter traffic from residential areas into the inner city, and vice versa, contributes disproportionately to weekday traffic jams.

In order to provide a convenient, roadworthy and environmentally friendly remedy for this, it is proposed that the vehicle should be operated electively as an autonomous fleet vehicle, in an entirely driverless manner, or is controlled by a person. For this purpose, the drive, tilting technology and regulation of the driving dynamics remain unchanged. In this case, the driver, who sits facing backwards, in the front part of the vehicle, in autonomous operation, is rotated by 180 degrees and faces forwards, and can control the vehicle manually. Immediately upon reaching the urban area that has the necessary infrastructure comprising radio transmitters, central control, and car-to-car communication, the driver can log the vehicle in there and have it travel in a fully autonomous manner. Vice versa, said driver logs out immediately upon reaching the edge of the autonomous region. In each case, the integrated navigation software ensures that the driver always knows whether the driving is currently manual or autonomous, or whether the driving can be autonomous or has to be manual.

For this purpose, in manual mode the vehicle is manually controlled with respect to the driving route (trajectory) and the speed, and the tilt angle suitable in each case for the bend radius, carriageway inclination, cross-wind and lane speed is set automatically by means of closed-loop control.

In a particular variant, the driver controls the vehicle using a control stick (joystick), by means of which the tilt or displacement to the side of the steering angle is specified. A forwards and backwards movement of the control stick generates a positive or negative acceleration, wherein the latter is preferably generated by means of recuperation of the electric drive or by means of inductive coupling. In the event of the decelerations achievable thereby not being sufficient, the control stick (joystick) is preferably pulled even further backwards, at increased force, as a result of which a mechanical brake is then hydraulically, pneumatically or mechanically or electrically activated. As a result of this control means, it is possible to avoid a complex and space-consuming arrangement of control elements, to which drivers of different sizes have to adapt by means of complicated seat adjustments. In an alternative embodiment of the vehicle, a steering wheel as well as brake and accelerator pedals (gas pedal) are provided for direction control.

Actuation by means of the control stick (joystick) does not interfere directly in the mechanical coupling members, but instead merely emits signals to electrical or hydraulic or pneumatic actuators, such that it is possible to use the same signal transmission for autonomous driving and for manual driving. In the event of driving that is not fully automated, warning and orientation signals and systems are used as driver assistance systems.

In regions in which fully automated driving using vehicles of the same design is permitted, the system can be used such that the vehicles travel in a manually controlled manner on the outskirts, on the way into the inner city. Upon reaching the city boundary, the vehicle receives a corresponding signal and can travel on autonomously from there. However, in comparison with exclusively using autonomous vehicles, the driver must park and charge the vehicle himself, after reaching the journey destination. In contrast, the public vehicles can drop the driver directly at the destination, and the publicly available vehicle can travel automatically to the closest parking place and charge up there and wait for a new customer.

In order to remedy the above disadvantages, four preferred alternatives are proposed:
1) The vehicle continues to drive autonomously as far as a privately rented and reserved carpark, which is possible only if the vehicle is in a territory where there is autonomous operation.
2) The vehicle drives to the closest public carpark that was reserved by the control center when the person got out.
3) The vehicle is supplied with programs, by means of a teach-in system, which programs always guide the vehicle to the same parking place, for example the home garage, inside or outside the autonomous region. In the case of a teach-in system, the driver drives a stretch manually, once, and the control signals are stored and can subsequently be called up as often as desired. In order to define starting coordinates from where the taught journey begins, a measurement is made using suitable sensors, preferably by means of radar/LIDAR/DGPS or a camera, set up at the starting point.
4) The vehicle is not a private vehicle, but instead belongs to a vehicle pool and is released following use and travels on autonomously.
In the last-mentioned case, the procedure for a typical commuter would then be such that the driver registers with the vehicle pool and can request and return a vehicle via app, in the autonomous region. Furthermore, said driver can also take vehicles to a destination outside the autonomous region, and park and charge them there overnight for example. In this case, charges are invoiced for the driving route and for the parking time outside the autonomous region, as well as the routes driven in the autonomous region.

The present invention therefore describes not only a tilting vehicle, but rather, in comparison with DE 102016008800, also an extended mobility concept comprising vehicles which can be used both in allocated autonomous regions, as a self-driving taxi, and also outside the autonomous region, as a car pool vehicle.

A further advantage of the invention is that, at times or in regions in which autonomous driving is permitted only when a driver is present, e.g. in what are known as model regions, for testing and authorization purposes, autonomous driving is possible when the driver is present, whereas vehicles without a driver would not be admitted.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1a is a perspective view showing a vehicle for transporting people, without a vehicle body;

FIG. 1b is a perspective view showing the vehicle for transporting people, without a vehicle body;

FIG. 2a is a perspective view showing the vehicle for transporting people, comprising a vehicle body;

FIG. 2b is a perspective view showing the vehicle for transporting people, comprising a vehicle body; and

FIG. 2c is a perspective view showing the vehicle for transporting people, comprising a vehicle body.

### DESCRIPTION OF PREFERRED EMBODIMENTS

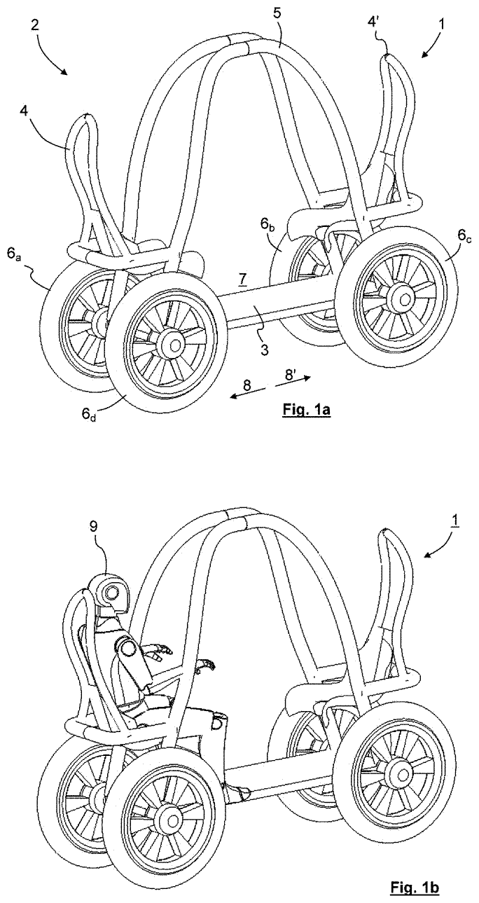

Referring to the drawings, FIG. 1a, b and 2a-c show a specific embodiment of a vehicle 1 according to the invention which is designed for transporting people. For this purpose, the vehicle 1 comprises a chassis 2 having a planar base 3 on which two mutually opposing seats 4, 4′ are arranged, and a frame structure 5 which, for safety reasons and as a precaution, can be designed as a roll-over bar. The vehicles 1 shown comprise four wheels 6a-6d which are arranged underneath and laterally offset from the seats 4, 4′. While the space 7 between the seats is designed as a luggage storage surface, electrical units (not shown) are arranged beneath the seats 4, 4′, which units are used for controlling the vehicle. Electrical wheel hub motors are not shown either, which motors are designed such that the vehicle can travel both forwards and backwards, in the direction of the arrows 8, 8′.

FIG. 1b shows the same vehicle 1 having a person 9 sitting on a seat.

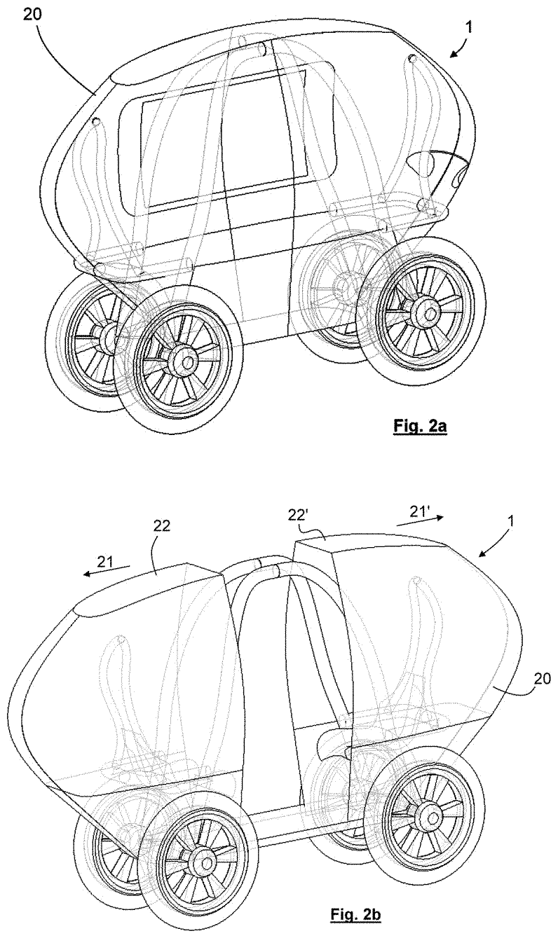

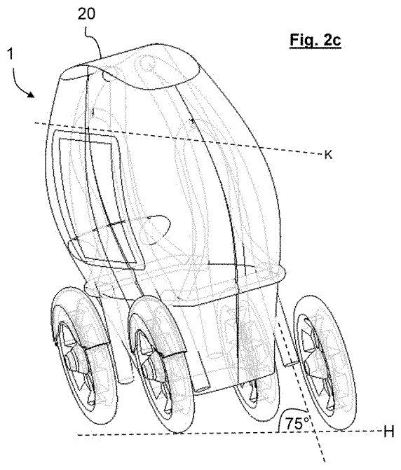

FIG. 2a-c show the vehicle 1 comprising a vehicle body 20 which consists of two vehicle body halves 22, 22′ which can be displaced relative to one another in the direction of the arrows 21, 21′. In order for people to get in and out, the vehicle body halves 22, 22′ are pushed outwards, and thus open the passenger compartment. Alternatively, a conventional hinged or sliding door can also be provided, via which the passengers can emerge from the vehicle body, and thus the vehicle 1. The planar base 3 of the vehicle as the preferred overall height of the vehicle of approximately 1.8 m makes it possible to get in and out comfortably.

The vehicle 1 is designed having a track width of less than 1.2 m, and is therefore what is known as a single-track vehicle. In order to still allow for safe cornering even at comparatively high speeds in the city-center region (maximum 70 to 80 km/h), despite the preferred height of 1.8 m, an automatic tilt kinematics is provided, which tilts the vehicle 1 towards the inside of the bend, about the tilt axis K, in accordance with the current speed, the loading state, and the upcoming and predetermined trajectory, said axis preferably being arranged at the height of the heads of the person/people sitting in the vehicle. FIG. 2c therefore shows the vehicle 1 at a tilt of approximately 75° relative to a horizontal H. For the sake of clarity, the actuators, by means of which a corresponding tilt of the vehicle 1 can be set, are not shown. In contrast, it is clearly visible in FIG. 2c that the planes of the wheels and the vertical axis of the vehicle are oriented so as to be mutually parallel in each position of the vehicle 1, which increases the driving stability of the vehicle. A virtual pivot axis is also shown, which is preferably at a height of between 1.5 and 1.8 m from the contact planes, and therefore at the height of the head of a person sitting in the vehicle, with the result that any transverse forces do not have any noticeable effect on the person to be transported. This prevents, for example, transported people from suffering from motion sickness.

While specific embodiments of the invention have been shown and described in detail to illustrate the application of the principles of the invention, it will be understood that the invention may be embodied otherwise without departing from such principles.

1. A single-track vehicle comprising:
a vehicle body;
three or four wheels providing a small track width in relation to a vehicle height; and
automatically controlled tilt kinematics, in which the vehicle body and the wheels tilt about a longitudinal axis of the vehicle ti-j.

2. A single-track vehicle according to claim 1, wherein the track width is less than 1.2 m and/or the vehicle height of at least 1.30 m, so as to allow for people to comfortably get into the vehicle and/or to allow for a comfortable sitting position for people.

3. A single-track vehicle according to claim 1, wherein the tilt kinematics is configured as vehicle stabilization, which automatically prevents tipping of the vehicle in the case of bends, in cross-wind, when people get in, and/or in the case of inclinations of the carriageway.

4. A single-track vehicle according to claim 1, the wheels and the vehicle body tilt by a same tilt angle, upon tilting, such that wheel planes and the vehicle body are oriented so as to be mutually parallel, irrespective of the tilt angle.

5. A single-track vehicle according to claim 1, wherein target value regulation which determines a magnitude and a direction of the tilt from input parameters, wherein the input parameters comprise
an upcoming bend radius,
an upcoming gradient and an upcoming carriageway inclination,
a vehicle speed and a vehicle mass distribution,
a transverse acceleration,
a possible asymmetric entry load, and a decentral load distribution inside the vehicle,
a cross-wind, and/or
lateral impacts, wherein the tilt of the vehicle is automatically controlled, in each position, such that a resultant of all the acting forces, including gravitational force and the centrifugal force, is oriented so as to be substantially in parallel with a direction of a vertical axis of the vehicle body and of a passenger compartment within the vehicle body.

6. (canceled)

7. A single-track vehicle according to claim 1, wherein a breakdown torque is generated by means of steering in an opposite direction from an upcoming trajectory, in the case of cornering, such that bends to the left are introduced by means of counter steering to the right, and vice versa.

8. A single-track vehicle according to claim 1, wherein the automatically controlled tilt kinematics comprises steering angle actuators and tilt actuators, which are designed such that the virtual tilting axis of the vehicle is at a height of from 1.5 m to 1.8 m above contact planes.

9-10. (canceled)

11. A single-track vehicle according to claim 1, wherein the automatically controlled tilt kinematics comprises a wheel suspension and/or an actuator system on double crossmembers, comprising linear guides having ball bearing circulation, a spindle drive, or electromagnetic coils, comprising torsion bars, or comprising trailing arms having a rotary bearing, by means of which wheel suspension and/or an actuator system the tilt of the vehicle body and the wheels about the longitudinal axis of the vehicle is made possible, wherein the vehicle the actuator system sets a tilt and the actuator system comprises the spindle drive, hydraulics, pneumatics, and/or electromagnetic coils.

12. (canceled)

13. A single-track vehicle according to claim 1, the automatically controlled tilt kinematics comprises a 4-wheel suspension and/or a 4-wheel hub drive, such that travel of the vehicle (II in both directions is possible, without restriction.

14. A single-track vehicle according to claim 1, wherein the vehicle is configured as a fully self-driving vehicle.

15. A single-track vehicle according to claim 1, wherein the automatically controlled tilt kinematics comprises characterized a tilt actuator system configured as electric spindle actuators or having an electric geared motor.

16-18. (canceled)

19. A single-track vehicle according to claim 1, wherein an overall length of the vehicle is less than 2.8 m, such that the vehicle is parkable transversely in a parking space, and is transportable transversely on other vehicles.

20. A single-track vehicle according to claim 1, further comprising a speed limiter controlled by means of GPS signals or signals from other external transmitters wherein the speed limiter prevents critical apex speeds from being exceeded.

21. (canceled)

22. A single-track vehicle according to claim 1, further comprising a pilot control, wherein
the automatically controlled tilt kinematics comprises actuators and is configured to locate a virtual axis of rotation in and on a center of the carriageway, or above tire contact planes; and
the pilot control performs leading closed-loop control of the automatically controlled tilt kinematics, such that the actuators do not work against built up transverse acceleration forces.

23. (canceled)

24. A single-track vehicle according to claim 1, wherein
the automatically controlled tilt kinematics comprises individual actuators of a chassis support and/or suspension arm; and
each suspension arm/chassis support is separate actuated individually, by a separate actuator in each case, wherein a longitudinal tilt of the vehicle is also controlled by the individual actuation of the chassis support and/or suspension arm.

25-27. (canceled)

28. A single-track vehicle according to claim 1, further comprising a manual controller wherein the vehicle optionally is manually controlled, or is connected to a central controller of an autonomous region, such that the vehicle is controlled autonomously and by the central controller, in the autonomous region.

29-31. (canceled)

32. A single-track vehicle according to claim 1, further comprising a manual controller and systems for autonomous driving in an autonomous region, wherein the vehicle is part of a vehicle fleet, wherein the vehicles can be driven both autonomously and manually, and can be rented individually by users, wherein the systems for autonomous driving in the autonomous region is used outside the autonomous region as driver assistance systems.

33. (canceled)

34. A single-track vehicle according to claim 32, wherein the vehicles allow for journeys between two different autonomous regions, wherein the vehicle is controlled manually between two autonomous regions, and a login to the central controller takes place upon reaching the further autonomous region, for which purpose suitable software is provided, if required.

35. (canceled)

36. A single-track vehicle according to claim 1, further comprising a front seat, wherein the front seat is mounted so as to be rotatable about 180°, such that a face-to-face position of seats can be set.
